(19) United States
(12) Patent Application Publication
(10) Pub. No.: US 2015/0165895 A1
(43) Pub. Date: Jun. 18, 2015

(54) SYSTEMS AND METHODS FOR PERSONAL ROBOTICS

(71) Applicant: ROAMBOTICS, INC., Glendale, CA (US)

(72) Inventors: Scott Menor, Glendale, CA (US); Tyler Anderson, Scottsdale, AZ (US); Daniel Stone, Chandler, AZ (US)

(21) Appl. No.: 14/572,720

(22) Filed: Dec. 16, 2014

Related U.S. Application Data
(60) Provisional application No. 61/917,090, filed on Dec. 17, 2013.

(51) Int. Cl. B60K 8/00; G05D 1/02

(52) U.S. Cl. CPC B60K 8/00; G05D 1/0225

(57) ABSTRACT

An autonomous mobile sensor platform may be provided which may be capable of freely roaming within an environment. The mobile sensor platform may include a wheel that may be laterally self stabilizing, and capable and encircle a robot body. The mobile sensor platform may sense one or more conditions using one or more types of sensors and react based on the sensed conditions. Examples of reactions may include alerting a user about the conditions. The mobile sensor platform can be used to monitor an environment or individuals within the environment.

### CROSS-REFERENCE

This application claims the priority of U.S. Provisional Application Ser. No. 61/917,090, filed Dec. 17, 2013, which is incorporated herein by reference in its entirety.

### BACKGROUND OF THE INVENTION

Traditionally, when individuals wish to monitor their home security or personal health, a large amount of infrastructure is needed to provide such monitoring. For example, home monitoring systems often require the addition of cameras with additional wiring and drilling. Furthermore, such added infrastructure is often embedded into the home structure and is not portable. Additionally, personal health monitoring often results in an individual wearing a monitor which can be cumbersome and uncomfortable.

A need exists for improved systems and methods for monitoring an environment or personal condition.

### SUMMARY OF THE INVENTION

An aspect of the invention is directed to a mobile sensor platform comprising: a wheel that permits the mobile sensor platform to move within an environment including an underlying surface; a stabilization platform in a body of the mobile sensor platform that is contained within an area circumscribed by the wheel, said stabilization unit causing the wheel to remain balanced upright on the underlying surface without tipping over; and one or more sensors configured to generate sensing data that aids the mobile sensor platform in moving with the environment. In some embodiments, the stabilization platform may include a lateral mass shifting mechanism.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of an autonomous mobile sensor platform in accordance with an embodiment of the invention.

FIG. 2 shows an additional view of an autonomous mobile sensor platform.

FIG. 3 shows an example of communications that may occur with the autonomous mobile sensor platform.

FIG. 4 shows an example of a system for low level control of an autonomous mobile sensor platform.

FIG. 5 provides an example of a gyroscopic stabilization platform.

FIG. 6 provides an example of a reaction wheel stabilization platform.

FIG. 7 provides an example of a mass shifting stabilization platform in accordance with an embodiment of the invention.

FIG. 8 shows an example of a turn table mass shifting stabilization platform.

FIG. 9 shops an example of a pendulum mass shifting stabilization platform.

FIG. 10 shows an example of a linearly displaceable mass shifting stabilization platform.

FIG. 11 shows an example of a system for high level control of an autonomous mobile sensor platform.

FIG. 12 further shows an example for high level control of an autonomous mobile sensor platform.

FIG. 13 provides a system for control of an autonomous mobile sensor platform.

FIG. 14 shows an example of a method for skill acquisition in accordance with an embodiment of the invention.

FIG. 15 illustrates an example of using positional information to determine functionality of an autonomous mobile sensor platform.

FIG. 16 provides an example of out-of-the-box functionality of an autonomous mobile sensor platform.

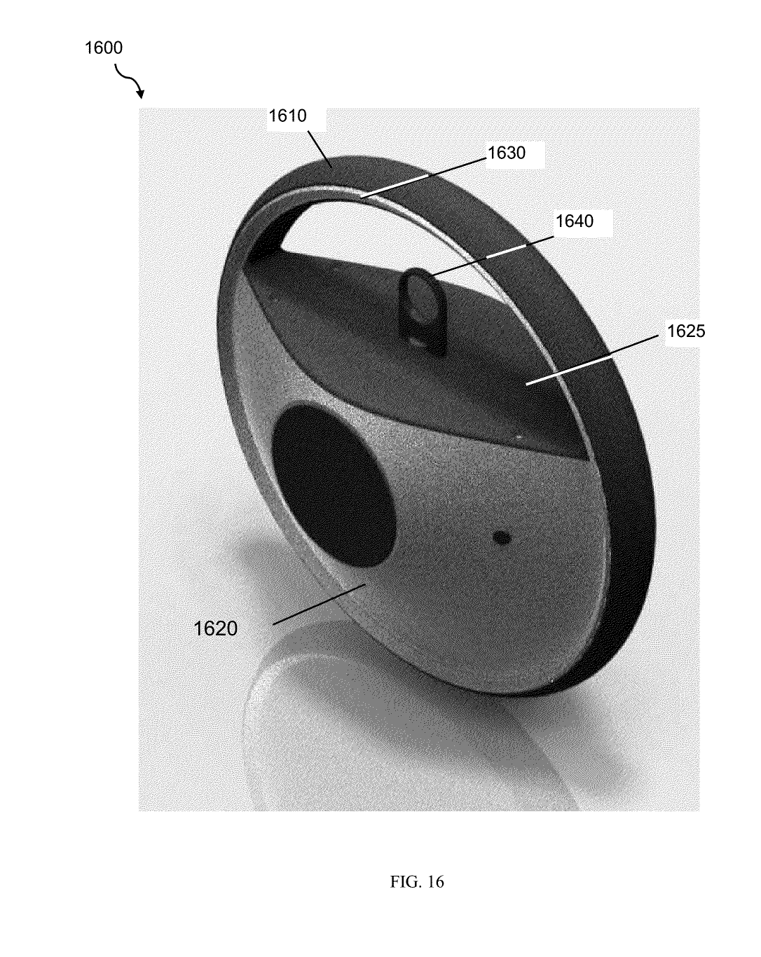

FIG. 17 provides a perspective view of a mobile sensor platform in accordance with an embodiment of the invention.

FIG. 18 provides an end view of a mobile sensor platform in accordance with an embodiment of the invention.

### DETAILED DESCRIPTION OF THE INVENTION

The invention provides systems and methods for autonomous mobile sensing. A mobile robot may be an autonomous mobile sensing platform. Various aspects of the invention described herein may be applied to any of the particular applications set forth below or for any other types of monitoring and communications applications. The invention may be applied as a standalone device or method, or as part of an integrated personal security or monitoring system. It shall be understood that different aspects of the invention can be appreciated individually, collectively, or in combination with each other.

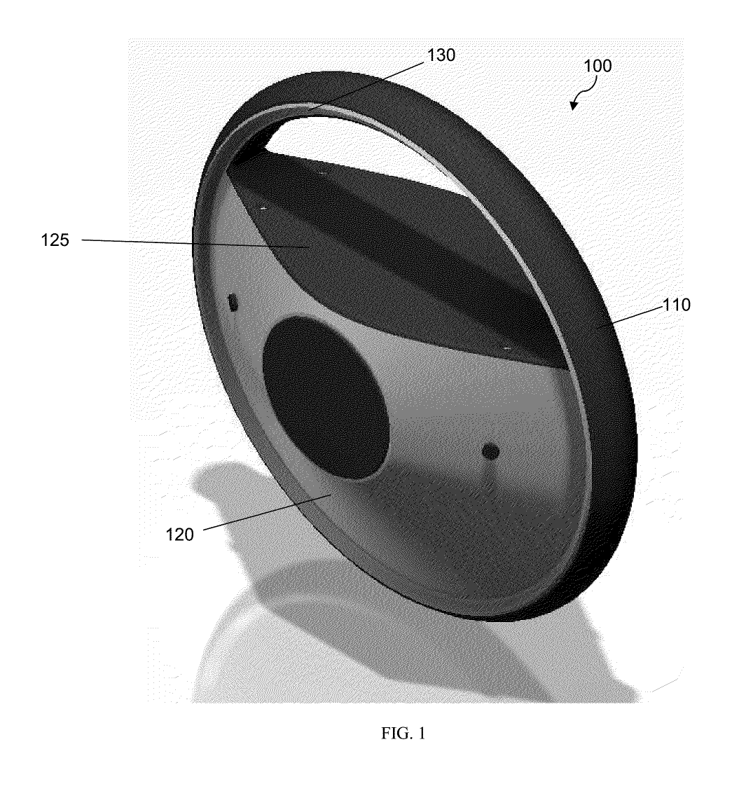

FIG. 1 shows an example of an autonomous mobile sensor platform 100 in accordance with an embodiment of the invention. The autonomous mobile sensor platform may be based around a self-stabilized unicycle platform. The mobile sensor platform may have a wheel 110 and a robot body 120. In some embodiments, the robot body may be shaped so that an open space is provided above, thereby forming a handle 130. The autonomous mobile sensor platform may also be referred to as a personal robot or “roambot.” The autonomous mobile sensor platform may also be a single-wheel robot.

The wheel 110 may contact a surface over which the mobile sensor platform may travel. The wheel may roll over the surface while the robot body 120 does not roll along with the wheel. For example, the robot body may remain stable and upright while the wheel rotates around the body. In some embodiments, the robot body may remain in substantially the same orientation relative to an underlying surface or fixed reference frame. The wheel may move relative to the body. In some instances the mobile sensor platform may have only one wheel without requiring any other wheels. The mobile sensor platform may be self-stabilized so that the wheel does not tip over while the mobile sensor platform is operating autonomously. In some embodiments, the wheel may remain substantially vertical (parallel to a direction of gravity, or orthogonal to an underlying surface). The wheel may remain substantially vertical in the absence of additional lateral forces. The wheel may also remain substantially vertical in response to a lateral force (e.g., may be resistant to tipping over when the wheel is pushed sideways). The wheel may have an elastomeric or resilient surface. In some example, rubber or polymer tires may be used. The wheel may optionally be formed from a high friction material that may prevent it from slipping or reduce slippage as it travels over a surface.

The wheel 110 may permit the mobile sensor platform to travel freely in an environment. The mobile sensor platform may be able to travel over flat surfaces or up and down inclines or slopes. The mobile sensor platform may move without having any wires or physical connections to an external power source or controller. The mobile sensor platform may be contained within an area circumscribed by the wheel. The wheel may rotate to travel over a surface. In some instances, the direction of travel may be altered by tilting the wheel. For example if the mobile sensor platform is traveling straight, and it is desired to travel to the right, the wheel may tilt slightly to the right. Similarly, if the mobile sensor platform is to turn left, the wheel may tilt slightly to the left. The wheel may also change direction of rotation to reverse direction for the mobile sensor platform. The wheel may remain in an upright vertical position when standing still and while in a fully operational state.

The robot body 120 may include a housing enclosing one or more components of the autonomous sensor platform. The housing may be encircled by the wheel 110. In some instances, the housing does not extend beyond the circumference of the wheel. Optionally, no part of the mobile sensor platform extends beyond the circumference of the wheel. The robot body may include one or more processing components, memory storage units, sensors, communication modules, and/or stabilization units. The robot body may also include an energy storage and/or generation system. The housing may contain all or some of these components. One or more processors may be housed within the robot body and may perform one or more steps or calculations as described herein. The processors may execute code, logic, or instructions provided in non-transitory computer readable media. One or more memory storage unit may store the non-transitory computer readable and/or data. In some embodiments, the non-transitory computer readable media may define action to be performed by the mobile sensor platform. It may also include skills or updates for the mobile sensor platform, to be described in greater detail elsewhere herein.

One or more sensors or types of sensors may be provided in or on the robot body. One or more of the sensors may be provided enclosed within the body housing. Alternatively, one or more sensor may be provided on or embedded in an external surface of the body housing. In some embodiments, the sensors may include, but are not limited to, position sensors, velocity sensors, accelerometers, orientation sensors, proximity sensors, motion sensors, magnetometers, microphones or other audio sensors, vibration sensors, cameras, light sensors, infrared sensors, temperature sensors, or smoke detectors. Additional examples of sensors may be described elsewhere herein. Some of the sensors may function to aid with the movement of the mobile sensor platform, while other sensors may aid with detecting conditions outside the mobile sensor platform. Data from one or more of the sensors may be collected and stored in memory on the autonomous mobile sensor platform. The data from one or more of the sensors may also be communicated to one or more external device through one or more communication modules. The one or more processors may use data from the sensors in effecting one or more action. The movement of the mobile sensor platform may depend on data from the sensors. For example, a proximity sensor may detect an obstruction in front of the mobile sensor platform. The mobile sensor platform may then change direction and travel around the obstruction. In another example, communications made by the mobile sensor platform may depend on data from the sensors. In one instance, an audio sensor may capture a sound that is analyzed to be suspicious. An alert may be sent to a mobile device of a user regarding the sound. In some embodiments, a body of the mobile sensor platform may be formed of a material that may be non-transmissive to some signals while remaining transmissive to other signals. This may permit sensors that detect the signals to which the body is transmissive to be located within the body and detect the signals from the environment. For example, the body may be formed from a material that permit infrared signals to pass through. Infrared sensors may be located within the body. The body may optionally be opaque to visible light.

A stabilization unit may be provided within the body to stabilize the body and assist with controlling movement. The stabilization unit may help the mobile sensor platform remain upright and be resistant to tipping. Examples of stabilization units are provided elsewhere herein.

An energy storage or generation unit may be provided in the robot body. An example of an energy storage unit may include a battery. The battery may be rechargeable and/or swappable. In some instances, the mobile sensor platform may interact with a charging station that may recharge the battery. One or more sensors may be provided that may monitor the state of charge of the battery. When the battery needs to be recharged, the mobile sensor platform may return to the charging station of its own volition. In some instances, inductive charging may be used to recharge the battery.

An autonomous mobile sensor platform may also have a handle 130. The handle may be provided over the body 120. In some instances, the body has a top surface 125 that does not go all the way up to the wheel 110, thereby creating a space. The top surface may be flat. The top surface may be oriented substantially orthogonal to the direction of gravity or an underlying surface. The top surface may remain oriented in such a direction even while the mobile sensor platform is traveling and/or the wheel is rotating. The handle may also include a portion of a wheel 110. The handle may permit a user to easily pick up the autonomous mobile sensor platform. In some embodiments, the autonomous mobile sensor platform may be dimensioned so that it can be picked up by a human. For example, the autonomous mobile platform may have a wheel diameter, or a robot body diameter of less than or equal to about 80 cm, 70 cm, 60 cm, 50 cm, 40 cm, 35 cm, 30 cm, 25 cm, 20 cm, 17 cm, 15 cm, 12 cm, 10 cm, 7 cm, 5 cm, 3 cm, 1 cm, or a fraction of a cm. The autonomous mobile platform may weigh less than or equal to about 6 kg, 5 kg, 4 kg, 3.5 kg, 3 kg, 2.5 kg, 2 kg, 1.7 kg, 1.5 kg, 1.2 kg, 1 kg, 0.7 kg, 0.5 kg, 0.3 kg, 0.2 kg, 0.1 kg, or 0.01 kg.

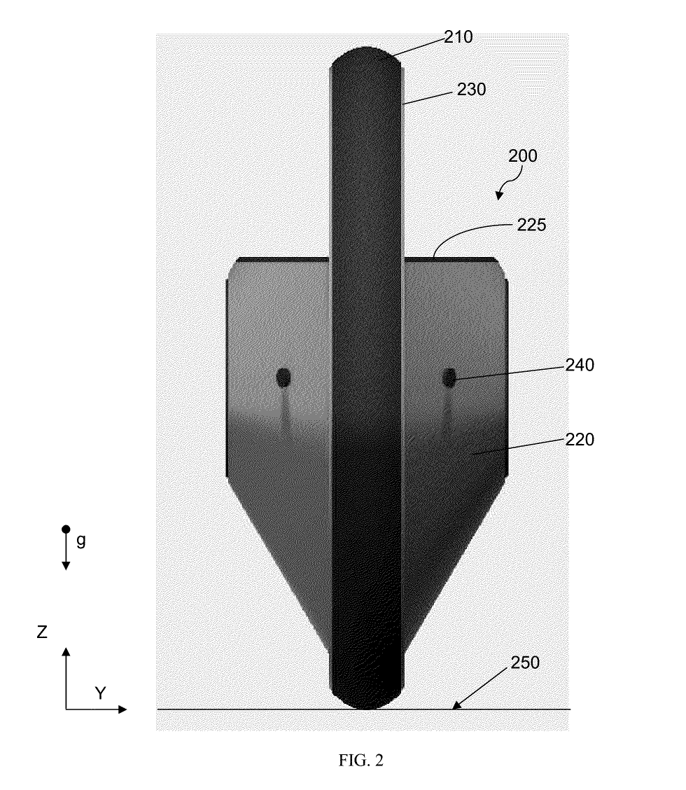

FIG. 2 shows an additional view of an autonomous mobile sensor platform 200. A wheel 210 may encircle the autonomous mobile sensor platform, which may be a personal robot. A robot body 220 may be provided within the circumference of the wheel. Optionally, the robot body does not protrude beyond the circumference of the wheel (e.g., in the Z- or in an X-direction). The robot body may protrude laterally (e.g., in a Y-direction) relative to the wheel. For example, the robot body may extend in both directions beyond the width of the wheel. In some instances, the width of the robot body may be less than, greater than, or equal to about 1×, 1.5×, 2×, 2.5×, 3×, 3.5×, 4×, 5× or 6× the width of the wheel. The robot body may have a top surface 225. The top surface of the robot body may be beneath the top of the wheel. A space may be provided between the top surface of the body and the upper portion of the wheel, forming a handle 230.

In some instances, one or more sensors 240 may be provided on the robot body 220. In some instances, the sensors may be on an external surface of the robot body housing, embedded within the robot body housing, or contained within the robot body housing. One or more different types of sensors may be employed by the autonomous mobile sensor platform. In some instances, optical sensors or image capture devices may be used. For example, cameras may be provided on a robot body to capture images around the robot body. In some instances, multiple cameras may be positioned on different portions of the robot body to capture different angles and fields of view. For example, one or more cameras may be provided facing away from one side of the wheel and one or more cameras may be provided facing away from the opposing side of the wheel. Multiple cameras may be capable of simultaneously capturing different fields of view, which may be viewable or accessible by a device of a user.

In some embodiments, an image registration system may be provided, which may identify distinct views with an environment and combine images from one or more cameras to form a composite that may be similar to having multiple fixed camera viewpoints. For example, an array of images may be provided (e.g., to a device of a user or other device) which may show the various camera angles. For example, a tiling effect may be provided, where each tile of an array shows a different angle provided a different camera. As one or more mobile sensor platform may move about an environment, these images may be updated to generate a tiling of distinct viewpoints. The viewpoints may be rank-ordered based on changes. In some embodiments, cameras may detect images of interest or activity, which may be displayed with greater emphasize (e.g., larger tile, zooming in on the tile, positioning the tile higher or more centrally).

The mobile sensor platform 200 may be on a surface 250. In some instances, the surface may be flat, curved, sloped, or have any other shape. In one example, the surface may be a floor of the user's home. In some instances, the surface may be oriented so that an axis orthogonal to the floor surface (e.g., Z-axis) is parallel to the direction of gravity (e.g., g). Alternatively, the surface may be sloped so that gravity is not orthogonal to the surface. The wheel 210 of the platform may rest on the surface. In some embodiments, when the mobile sensor platform is at rest, the platform is stabilized so that the wheel is parallel to the direction of gravity (e.g., upright relative to the direction of gravity). This may occur regardless of whether the underlying surface is orthogonal relative to the direction of gravity. When the mobile sensor platform is moving, its vertical orientation may be controlled to permit it to move in the desired direction.

An autonomous mobile sensor platform may freely traverse an environment while sensing the environment around it. The autonomous mobile sensor platform may traverse the environment by rolling over a surface, such as a floor, with a single wheel. The autonomous mobile sensor platform may roam the environment without knowing the layout ahead of time. It may sense the environment to avoid obstructions and prevent it from running into objects or structures. It may also sense moving or live beings and not run into them as well. The autonomous mobile sensor platform may traverse an environment and respond to detected conditions or obstructions in real-time.

The autonomous mobile sensor platform may also sense and analyze information about the environment around it. It may be able to detect certain conditions that may require certain actions. For example, certain conditions may cause it to approach to investigate, retreat and hide, send information to a device of a user/owner, send information to other entities (e.g., emergency services). These conditions can be sensed using one or more sensors of the mobile sensor platform. Information from a single sensor or multiple sensors combined can be analyzed to detect whether a condition that requires an action is in place. The mobile sensor platform can be used to monitor building/home security, building/home safety, and/or provide personal monitoring. Further examples of these functions can be described elsewhere herein.

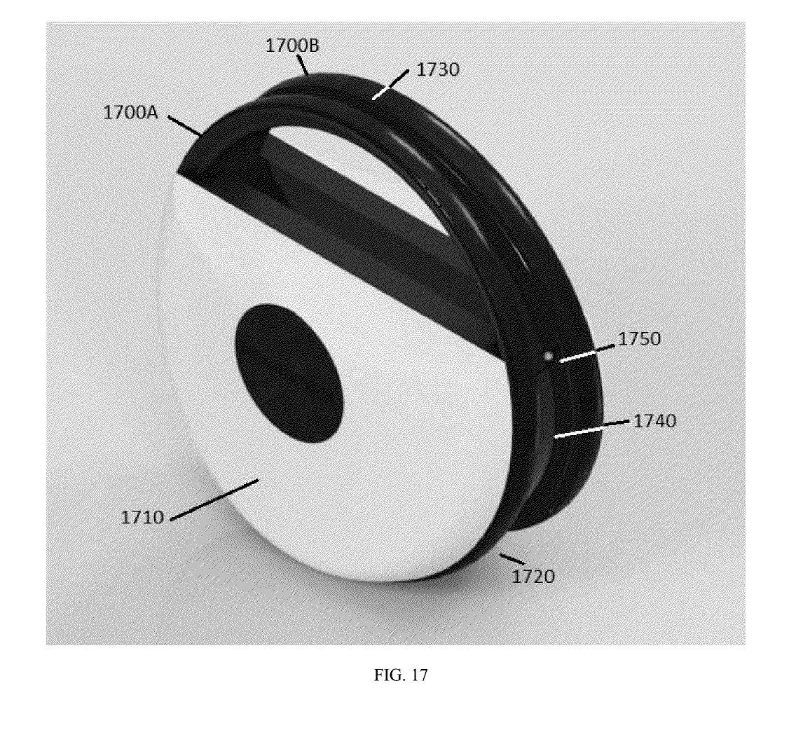

FIG. 17 provides an example of a mobile sensor platform in accordance with another embodiment of the invention. The mobile sensor platform may include a first wheel 1700A and a second wheel 1700B. A mobile sensor platform body 1710 may be circumscribed by the first wheel and/or the second wheel. The first wheel and the second wheel may be arranged so that they are arranged adjacent to one another. The first wheel and the second wheel may rotate about substantially the same axis of rotation. The first wheel and second wheel may be substantially parallel to one another or may be at a slight angle relative to one another. The circumferences of first wheel and the second wheel may be substantially aligned to one another so that they may encircle the space or region, or cylindrical area therein. The wheels may be configured to rotate together or may rotate independently of one another. In some instances, the wheels may rotate in the same direction or different directions. The wheels may rotate at the same angular speed or different angular speeds. The mobile sensor platform may be capable of rotating in place.

In some embodiments, the wheels may be slightly angled so that a base 1720 has a greater distance between the wheels than a top surface 1730. This may provide greater stability on the base while enabling a user to easily pick up the device through a handle. In some instances, a division 1740 may be provided between the wheels that may enable them to rotate at different rates or directions. In some embodiments, a light 1750 may be provided. The light or any other lights described elsewhere herein may be able to blink or change color. The blinding or change in color of light may indicate different states of the mobile sensor platform as described elsewhere herein, such as mood, level of power remaining, detected environmental conditions, and so forth.

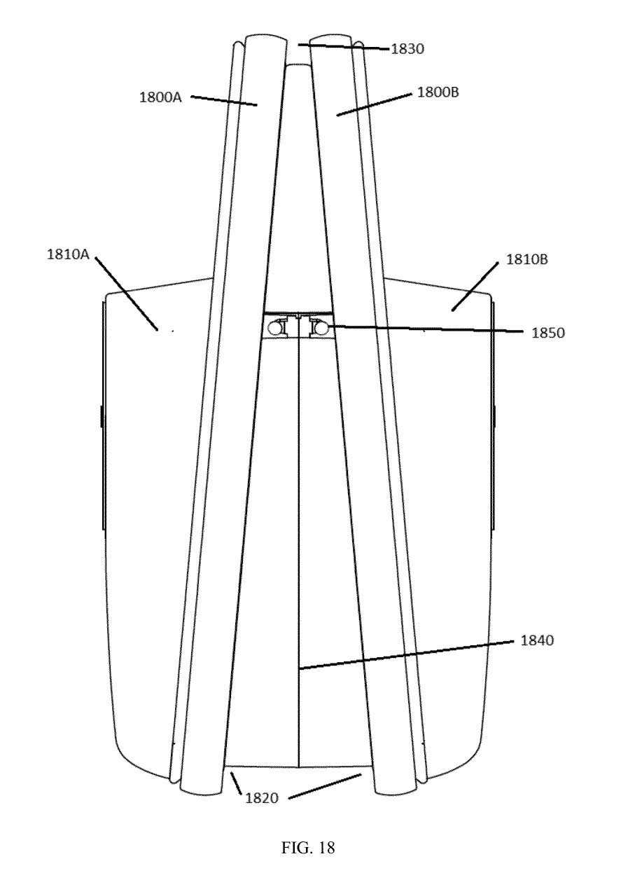

FIG. 18 shows an additional view of a mobile sensor platform having multiple wheels in accordance with an embodiment of the invention. As shown in FIG. 18, a first wheel 1800A and a second wheel 1800B may be provided so that they circumscribe a body. The body may have a first portion 1810A and a second portion 1810B. The first and second portions may or may not move relative to one another. In some instances the first and second portions may refer to first and second sides that may form an integral body. The mobile sensor platform may have a wider base 1820 than top 1830. A division 1840, such as a crack may be formed between two sides of the mobile sensor platform. Alternatively, no division may be provided. The wheels may move independently of one another with or without a division. One or more lights 1850 may be provided.

Any description herein of a single wheel mobile sensor platform may also apply to mobile sensor platforms with multiple wheels (e.g., two, three, four, five or more) that may be adjacent to one another as described. In addition to a single wheel one or more additional wheels may be provided. The multiple wheels may be substantially used to encircle the same space or body. The multiple wheels may have a circumference wheel that may be aligned to encircle the same cylindrical or ellipsoidal space.

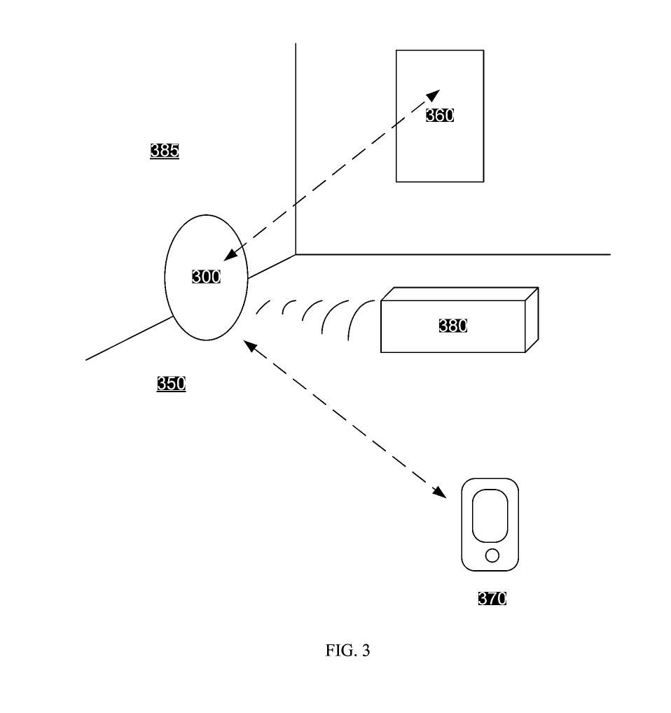

FIG. 3 shows an example of communications that may occur with the autonomous mobile sensor platform 300. The mobile sensor platform may be on a surface 350, such as a floor of a user's home or other building. The mobile sensor platform may be capable of communicating with one or more external device, such as a charging station 360 or a mobile device 370 of the user. In some embodiments, the communications between the mobile sensor platform and an external device may occur directly (e.g., via Bluetooth, infrared communications). Examples of direct wireless communications may also include wifi, wimax, cofdm. In some instances, communications may occur with aid of a router or relay station. Communications may occur over a network (e.g., local area network (LAN), wide area network (WAN) such as the Internet, telecommunications network (e.g., 3G, 4G)) or any other technique. Communications may be two-way communications (e.g., transmitting and receiving). Alternatively, one-way communications may also be employed (e.g., only transmitting or only receiving).

In some embodiments, different communication techniques may be used for different external devices. For example, a direct communication may be provided between the mobile sensor platform 300 and the charging station 360. In some instances, the mobile sensor platform may be able to locate the charging station via the communications and travel to the charging station when the mobile sensor platform needs to be charged. A beacon may be provided by the charging station that the mobile sensor platform may sense. Optionally, the beacon may be an infrared signal.

In another example, the mobile sensor platform 300 may communicate with a user's device 370 over a network. Examples of the user's device may include but are not limited to a personal computer, server computer, laptop, tablet, satellite phone, smartphone (e.g., iPhone, Android, Blackberry, Palm, Symbian, Windows), cellular phone, personal digital assistant, Bluetooth device, pager, land-line phone, or any other network device. In some embodiments, the device may be a mobile device. A mobile device may be easily transportable (e.g., tablet, smartphone). In some instances, the mobile device may be a handheld device. The device may be capable of communicating with a network. In some instances, the device may be capable of communicating with the network wirelessly and/or over a wired connection. The device may have a programmable processor and/or a memory. The memory may be capable of storing tangible computer readable media which may comprise code, instructions, and/or logics for one or more steps described herein. The programmable processor may be capable of performing one or more steps described herein in accordance with the tangible computer readable media. Optionally, a user may have multiple devices, the mobile sensor platform may simultaneously communicate with the multiple devices.

A user device 370 may have a display. The display may permit a visual display of information. The display may include a display of a browser and/or application. A viewable area of the canvas on the display may be a viewport. The display may be provided on a screen, such as an LCD screen, LED screen, OLED screen, CRT screen, plasma screen, touchscreen, e-ink screen or any other type of display device. The devices may also include displays of audio information. The display may show a user interface. A user of the system may interact with the device through a user interface. A user may interact via a user interactive device which may include but is not limited to a keypad, touchscreen, keyboard, mouse, trackball, touchpad, joystick, microphone, camera, motion sensor, IR sensor, heat sensor, electrical sensor, or any other user interactive device. When certain conditions are sensed by the mobile sensor platform, an alert may be sent to the user device. In some instances, communications may be pushed from the mobile sensor platform. In other embodiments, communications may be pulled from the user device. For example, a user may check in to see what images are currently being shown captured by the mobile sensor platform. For example, a user may check a live feed of snapshots or video images from the mobile sensor platform. In some instances, the user may direct the mobile sensor platform to perform one or more action.

The user device may or may not be in the same room or same building as the mobile sensor platform when the communication is provided. In some embodiments, the user may be outside the user's home and may leave the mobile sensor platform at the user's home. When a condition is detected, the mobile sensor platform may send information to the user's device, when the user is away and/or when the user is home. If the user is not present, the user may optionally be able to provide instructions to the mobile sensor platform to take further action (e.g., to investigate further, or to contact authorities). Alternatively, the user may not provide further instructions to the mobile device. The mobile device may communicate via text alerts and/or images/video. The mobile device may also provide audio information.

The mobile sensor platform 300 may also receive software updates or upgrades. Such updates may occur automatically without requiring human interaction. For example, when a new update is available, it may be sent to the mobile sensor platform. In some instances, updates may be provided with the aid of human interaction. For example, one or more functionalities or upgrades may be selected or chosen by the user. In some instances, the user may purchase different functionalities or upgrades. When the selection has been made and finalized, the updates may be provided to the mobile sensor platform. Such updates may be provided wirelessly (e.g., via direct communications from an external device, router, relay station, and/or over a network).

The mobile sensor platform may be capable of operating and moving autonomously. The mobile sensor platform may have one or more sensors that may permit it to navigate its environment without requiring human intervention. In some instances, one or more sensors may be used to sense the environment the mobile sensor platform and aid in navigation. For example, a proximity sensor or motion sensor may sense an obstruction 380 or wall 385 so that the mobile sensor platform does not run into them. Similarly, the mobile sensor platform may sense the presence or movement of humans or pets. Various sensors may also sense the orientation of the mobile sensor platform and aid in stabilization of the mobile sensor platform.

In some embodiments, the mobile sensor platform may be an autonomous robot having a minimal or reduced amount of hardware complexity. The mechanical simplicity of mobile sensor platform may allow the bulk of complexity to be pushed into software. This may advantageously permit the device to be highly manufacturable at high quality and low cost, while supporting significant upgrades through software updates.

### Standing and Low-Level Control

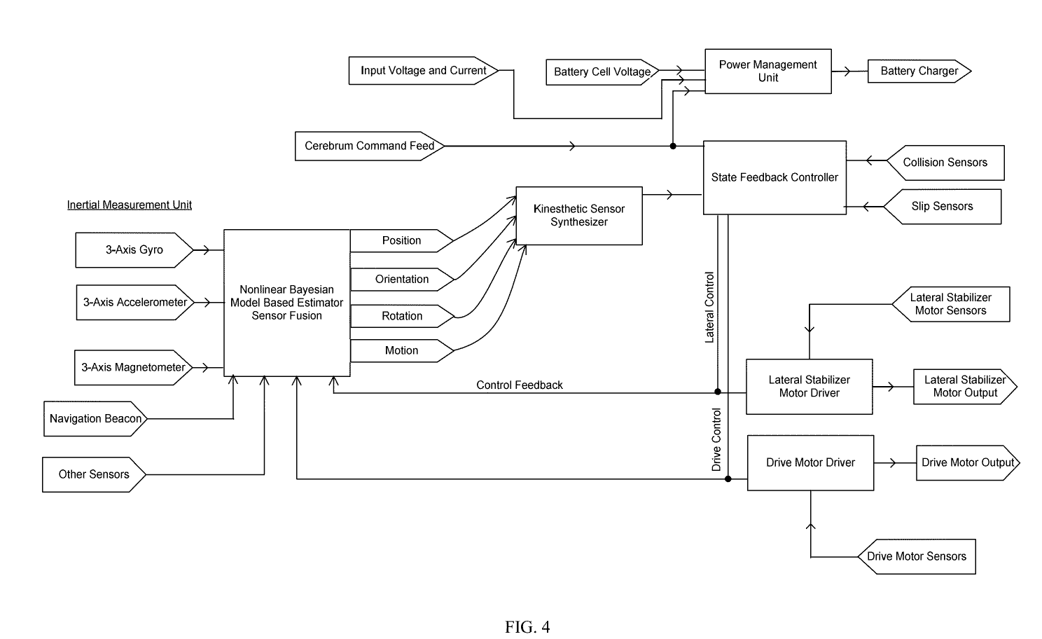

FIG. 4 shows an example of a system for low level control of an autonomous mobile sensor platform. In some embodiments, low level control may be handled by a low level (e.g. “medulla”) controller. The medulla controller's firmware may include an inertial navigation system (a.k.a. international measurement unit (IMU)) using some combination of accelerometers, gyroscopes, magnetometers, other sensors, or combinations thereof to detect position and orientation in space. For example, the IMU can include up to three orthogonal accelerometers to measure linear acceleration of the movable object along up to three axes of translation, and up to three orthogonal gyroscopes to measure the angular acceleration about up to three axes of rotation. Alternatively, the IMU can use a multi-directional accelerometer that can measure linear acceleration the three orthogonal directions, and/or a multi-directional gyroscope or other sensor that can measure angular acceleration about three axes of rotation. The IMU can be rigidly coupled to the autonomous mobile sensor platform such that the motion of the movable object corresponds to motion of the IMU. The IMU may be provided exterior to or within a housing of the mobile sensor platform. The IMU can provide a signal indicative of the motion of the mobile sensor platform, such as a position, orientation, velocity, and/or acceleration.

Low level control also includes basic collision avoidance, slip detection and response, and other protective behaviors that prevent damage of the autonomous mobile sensor platform or people, or the user's property/pets. In some instances, low level control may pertain to basic movements and stabilization of the mobile sensor platform.

In one example, as shown in FIG. 4, an internal measurement unit may include a 3-axis gyroscope, 3-axis accelerometer, 3-axis magnetometer, navigation beacon, and optionally other sensors, such as vision sensors. Optionally, information pertaining to lateral stabilization and drive of the mobile sensor platform may also be provided. Sensor fusion may occur. In some instances a nonlinear Bayesian modal band estimator may be used for sensor fusion. This may be used to provide positional information of the mobile sensing platform, which may include position information, orientation information, rotation information, and motion information of the mobile sensor platform. This information may be provided to a kinesthetic sense synthesizer, which may provide information to a state feedback controller. Information from various additional sensors may be provided to the state feedback controller, such as a one or more collision sensors or slip sensors. In some instances, information from a high level controller (a.k.a. “cerebrum” controller) may also be provided to the state feedback controller. Optionally, the state feedback controller may provide drive control and/or lateral control.

The state feedback controller may provide control signals to a drive motor driver. The feedback controller may aid in controlling the drive of the mobile sensing platform. The drive motor driver may provide a drive motor output (e.g., on/off, speed of motion). One or more drive motor sensors may provide feedback to the drive motor driver. For example, if an instruction is provided for the drive motor to turn at a certain speed, but no movement is detected by the sensors, an alert may be provided.

Lateral stabilization may occur for the mobile sensing platform. Such lateral stabilization may occur within its own system without requiring input from the state feedback controller. Alternatively, information from the state feedback controller may be considered. A lateral stabilizer motor driver may receive input from one or more lateral stabilizer motor sensors. Based on information from the sensors, the lateral stabilizer motor driver may provide a lateral stabilizer motor output to provide the desired stabilization effect. Various lateral stabilization techniques are described elsewhere herein.

Information pertaining to drive control and lateral stabilization control may be provided for sensor fusion along with data from the IMU.

Information from the high level controller (e.g., cerebrum controller) may also be provided to a power management unit of the mobile sensor platform. The power management unit may also receive information about input voltage and current, and energy storage (e.g., battery cell) voltage. The power management unit may be used to determine state of battery charge and whether the battery needs to be charged. If the battery does need to be charged, instructions may be provided to cause the mobile sensor platform to move to a charging station.

Medulla controller firmware updates can be performed over the air when the mobile sensor platform is sleeping and/or docked. In some instances, updates may be performed while the mobile sensor platform is at rest and not moving. Alternatively, it may be updates while moving. Furthermore, there is support for rolling back to the previous known-good firmware in the event of an emergency or critical medulla controller failure.

### Balance and Stabilization

Several workable approaches can be provided for balance and stabilization of the mobile sensor platform. Examples of such approaches may include gyroscopic stabilization, reaction wheel, or mass shifting stabilization. Such approaches may be in used in the alternative or in combination. Alternative lateral stabilization mechanisms may also be used.

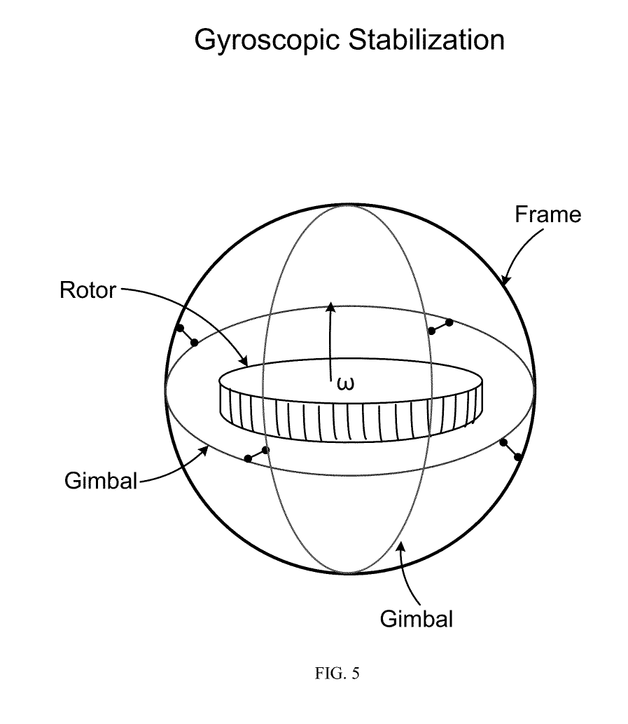

FIG. 5 provides an example of a gyroscopic stabilization platform. The gyroscopic stabilization platform may be enclosed in a housing of a robot body of the mobile sensor platform. A frame may be provided with one or more gimbals. The rotor may be supported by the frame and one or more gimbals. The rotor may be rapidly rotating. In order to provide a sufficiently large moment of inertia I, the rotor may have a significant mass. Torques applied to the system may be countered to preserve the ω vector.

Gyroscopic stabilization may offer many advantages but may also require a massive wheel/rotor with a significant moment of inertia to be constantly spinning at high speed. Gyroscopic stabilization may also require several other axes of gimbal control, significantly increasing power consumption and complexity.

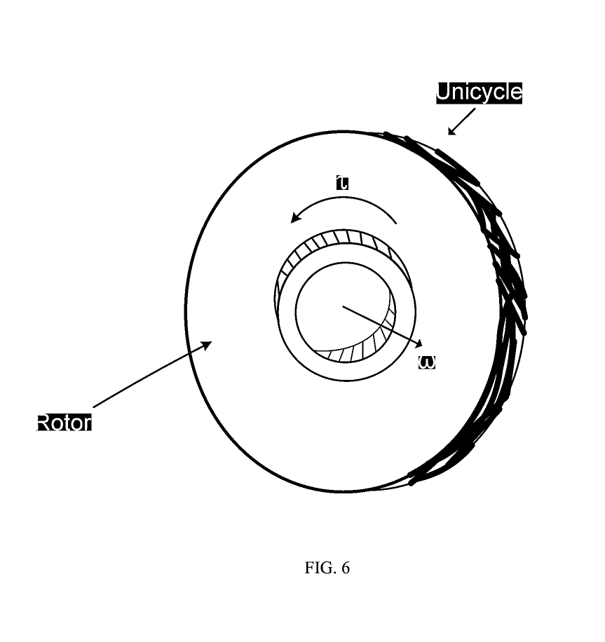

FIG. 6 provides an example of a reaction wheel stabilization platform. The reaction wheel stabilization platform may be enclosed in a housing of a robot body of the mobile sensor platform. The reaction wheel may include a rotor mounted with its axis in the direction of motion (e.g., direction the mobile sensor platform is traveling). Rotating the rotor in a vertical plane perpendicular to the direction of motion may provide a stabilizing effect. The ω vector may be provided in the direction of motion. A torque τ may be generated by the rotation. The torque τ applied to the rotor may impart a counter torque to the robot body.

Reaction wheels may have a limitation in that they can accumulate spin due to external torques. When spinning, they may also impart undesirable gyroscopic torques on the system which must be compensated for and canceled out. Thus, reaction wheels may result in additional complexity.

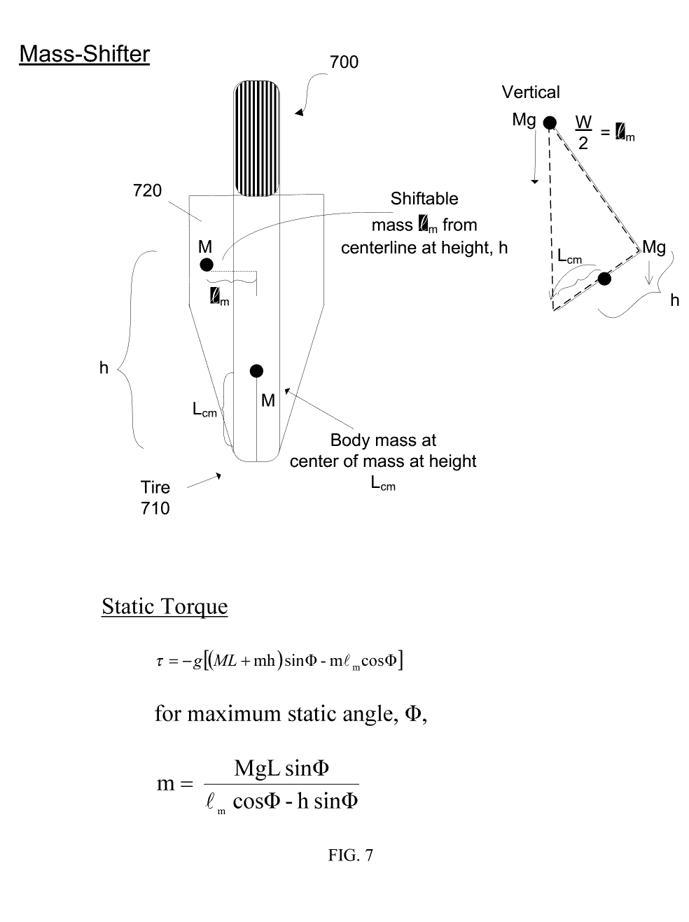

FIG. 7 provides an example of a mass shifting stabilization platform in accordance with an embodiment of the invention. A mass shifting stabilization platform may be enclosed within a housing of a robot body 720 of a mobile sensor platform 700. A wheel/tire 710 may encircle the robot body. In some embodiments, mass shifters can take the form of a pendulum, a wheel with a mass, or a belt/other linearly displaceable system to restrict movement of the balancing mass to the side-to-side direction.

The robot body may have a body mass M at the center of mass. The center of mass M may fall within the same plane as the wheel. A centerline may be provided in the same plane as the wheel. The center of mass may be provided at a height L_{CM}. A shiftable mass m may be provided. The mass m may shift laterally lₘ from the centerline. Shiftable mass m may be provided at height h. In some embodiments, h>L_{CM}. Alternatively, h=L_{CM}, or h<L_{CM}.

FIG. 7 provides illustrations of calculating the mass m of the shiftable mass for a maximum static angle φ. Different ways of shifting the mass laterally may be provided. The masses may be shifted laterally quickly or with high frequency.

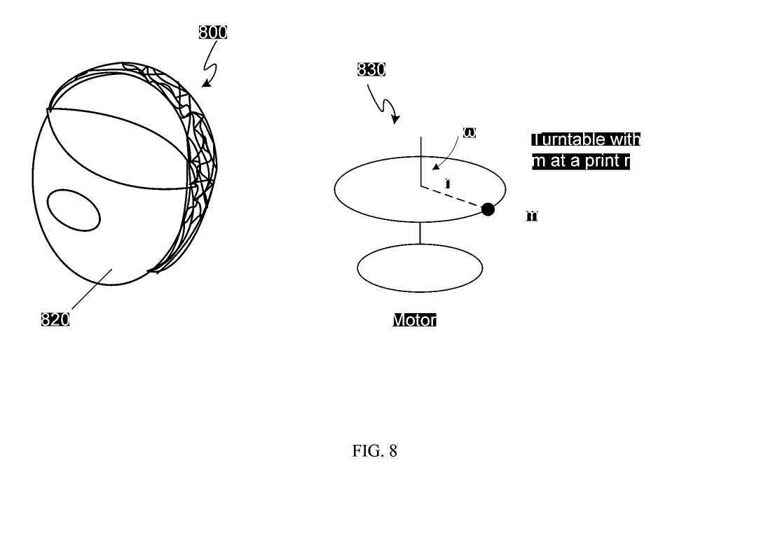

FIG. 8 shows an example of a turn table mass shifting stabilization platform. An autonomous mobile sensor platform 800 may be provided. The mobile sensor platform may have a body 820 including a housing which may enclose the turn table mass shifting stabilization platform 830.

Mass m may be supported on a turntable and provided at radius r away from the axis of rotation. The turntable may spin at an angular velocity ω. A motor may turn the turntable to position mass m at the desired location. This may advantageously provide a mechanical simple stabilization platform. However, in addition to shifting the center of gravity, a torque may be applied to the turn table and may leave the motor unbalanced.

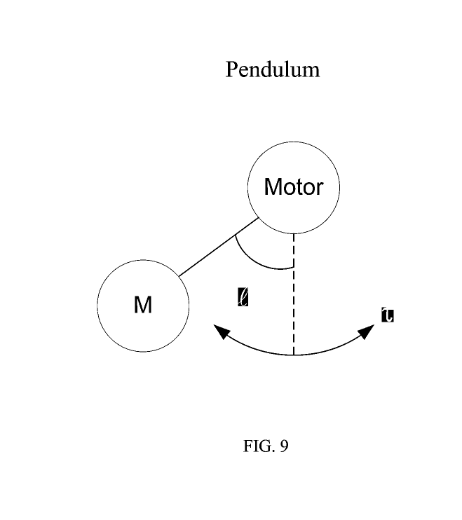

FIG. 9 shows an example of a pendulum mass shifting stabilization platform. A mass m may hang from a motor. The motor may swing the mass m to an angle to provide a desired lateral displacement l of the mass.

This pendulum configuration may also be mechanically simple. In some implementations work will be done to lift the mass. Lifting the mass may increase the mass required to maintain the wheel at a static angle.

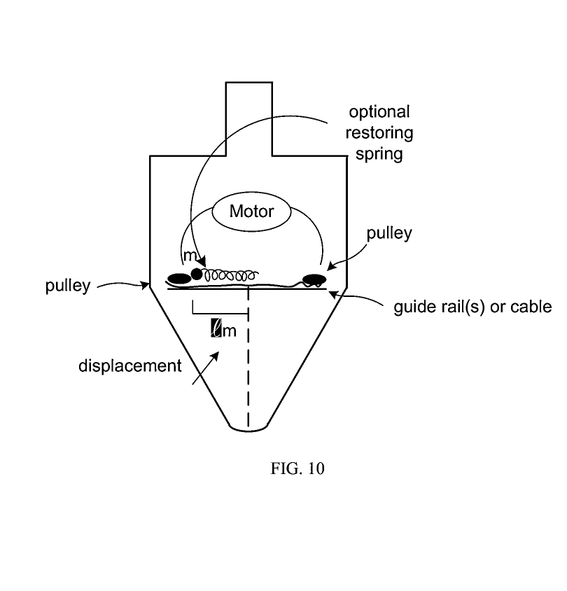

FIG. 10 shows an example of a linearly displaceable mass shifting stabilization platform. A mass m may be supported on a belt or other component. One or more pulley may be provided at opposite ends of the belt. Turning a pulley may cause the belt to move along with the rotation of the pulley. In some instances, guide rail(s) or cable(s) may be provided. A motor may cause one or more of the pulleys to turn, which may cause lateral movement of the mass on the belt. For example, a mass may move a distance lₘ from a centerline. Optionally, a restoring force may be provided to pull or push the mass back toward the centerline. For example a spring may be used.

In one implementation, the mobile sensor platform may use a linear mass-shifter driven by a brushless DC or servomotor and a synchromesh cable or timing belt.

A linearly displaceable mass shifting stabilization platform may be mechanically more complex than some of the simplest options. However, the linear mass shifting may advantageously occur at a fixed height. The motor does not need to significantly lift mass, thus saving energy. This may increase battery life for a mobile sensor platform. The use of a restoring component, such as a spring or hydraulic/pneumatic cylinders may reduce complexity of control and power required.

Mass shifting can stabilize a mobile sensor platform through changes in the center of gravity, moment of inertia, and through reaction forces due to applying force to reposition the mass. Changing the center of gravity of the overall mobile sensor platform allows the mobile sensor platform to statically balance under control at some non-zero angle, or on a non-level surface. Balancing at a non-zero angle and driving forward causes the wheel to rotate about the vertical axis. Changing the moment of inertia can be used to make the drive motor which usually just drives forward/backward movement and also causes rotation about the vertical axis. Reaction forces can allow transient excursions to angles beyond the maximum static angle supported by the device. In an extreme case, this could include leaping from the mobile sensor platform lying on its side to standing, although this requires significant acceleration of the balancing mass.

Two or more of the above approaches to lateral stabilization can be employed in a single device, if desired. Regardless of the mechanical realization, various types of controllers can effectively stabilize the mobile sensor platform.

### High Level Control

Higher level control may be handled by a high level controller (a.k.a. “cerebrum” controller). The cerebrum controller may run an operating system (e.g., RoamOS, which may be a custom, encrypted and highly secure operating system). The cerebrum controller may optionally interact with a lower level controller (e.g., medulla controller).

The cerebrum controller and the operating system can run third party applications (skills) in a sandboxed environment. In some instances, while the medulla controller may handle basic functions of the mobile sensor platform, the cerebrum controller may handle higher level functions and analysis. The mobile sensor platform can acquire new skills which may be downloaded to the platform.

Sensitive sensor data (e.g., stills/motion video; audio; etc.) can be restricted from third party software and can be handled through calls to the operating system services to protect end-user privacy. Sensitive sensor data may only be accessible by the user.

The operating system can be updated and the cerebrum controller rebooted without interfering with medulla controller operation so it is possible to do both while the mobile sensor platform is actively performing basic stabilization and collision avoidance without causing a catastrophic failure.

The operating system updates can be packaged as encrypted and cryptographically signed deltas. In some embodiments, only major updates require a reboot so almost everything can be safely updated while running without interfering with other functions.

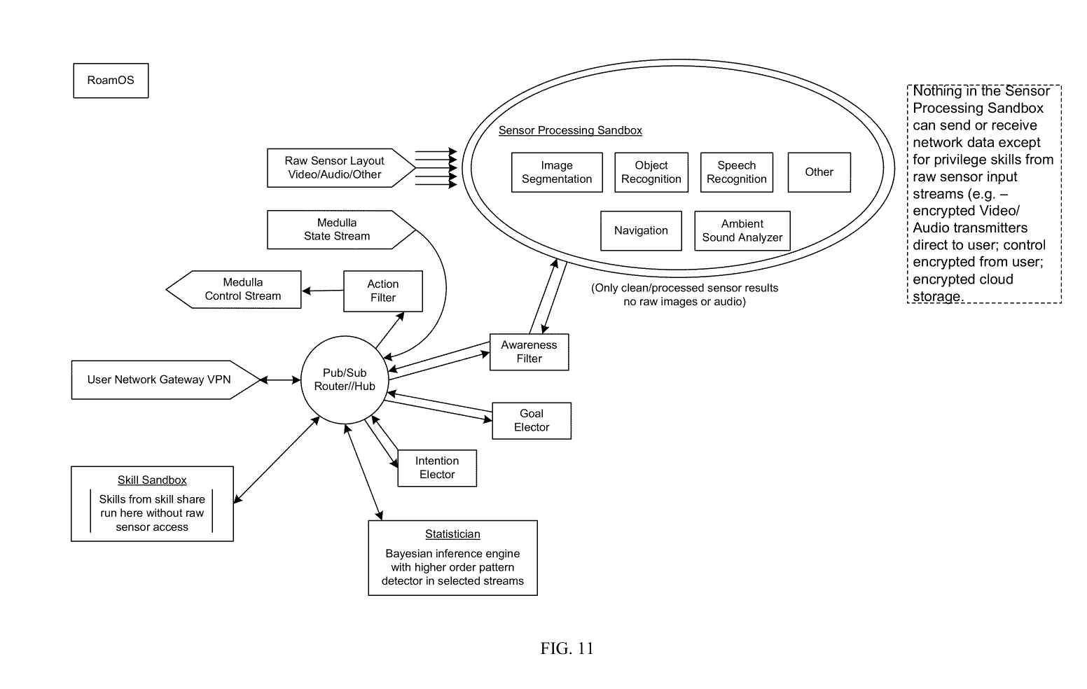

FIG. 11 shows an example of a system for high level control of an autonomous mobile sensor platform. A publishing/subscription (“pub/sub”) router/hub may be provided. Communications may occur through different components of the system and the pub/sub router/hub. The pub/sub router/hub may allow skills and other operating system services to define channels, broadcast messages on those channels, and to dynamically subscribe and unsubscribe from those channels. This may be a core service provided by the operating system.

A user network gateway may communicate with the pub/sub router/hub. The user network gateway may use a virtual private network (VPN). Two way-communications may be provided between the VPN and the pub/sub router/hub.

The pub/sub router nub may also communicate with the statistician, which may be another core service. When the statistician is directed to monitor a channel, it may accumulate observations about the data stream. The statistician may be capable of making empirically based Bayesian inferences and associations, with the additional ability to detect long-term patterns and trends. A higher order pattern detection may be provided in selected streams. These associations can later be queried by other services or skills via the pub/sub router.

Sensitive acquired data may be encrypted and transported to a user's device, or to external storage. In these cases, encryption is such that only the user has the decryption key while third party developers, and the mobile sensing platform administration system, do not have the ability to decrypt the data.

Communications may also occur between the pub/sub router/hub and a skill sandbox. The skill sandbox may include skills from a skill store. The skills may be provided by a mobile sensor platform administrator or a third party developer. The skills may be an application that may provide additional functionality to the mobile sensor platform.

The pub/sub router/hub may also interact with an intention elector, which may be a weighted voting system for determining a rank-sorted list of actions in the immediate future, and/or a goal elector, which may be a weighted voting system for determining a rank-sorted list of longer term objectives.

Additionally, the pub/sub router/hub communicates with an awareness filter that may identify sensor data that is relevant to current activities and removes extraneous and irrelevant sensor data.

A sensor processing sandbox may be provided. Examples of processed sensor data may include image segmentation, object recognition, speech recognition, navigation, ambient sound analysis, or other. In some instances, only clean/processed sensor results are provided in the sensor processing sandbox. For instance, raw images and/or audio may be excluded. Optionally, such data may be stored in a different portion of memory. Alternatively, raw images and/or audio data may be included.

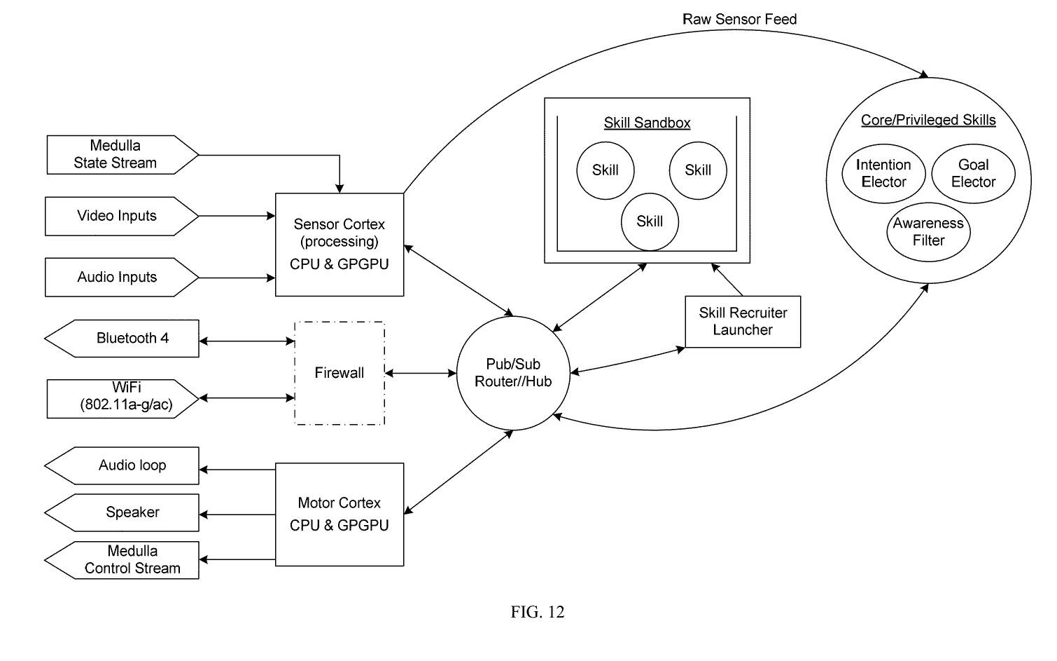

FIG. 12 further shows an example for high level control of an autonomous mobile sensor platform. A pub/sub router/hub may be in communication with a sensor cortex, which may be used for processing sensed information. The sensor cortex may include one or more central processing unit (CPU) and/or general-purpose computing on graphics processing units (GPGPU). Inputs, such as a medulla state sensor, one or more video/image inputs, and/or audio inputs may be provided to the sensor cortex. Thus, visual and/or audio information sensed by the mobile sensor platform and information about the low level controller may be provided to the sensor cortex, and communicate with the pub/sub router/hub.

The pub/sub router/hub may also communicate with one or more communication system. A firewall may optionally be provided. Examples of communication systems may include but are not limited to Bluetooth and wifi.

The pub/sub router/hub may also communicate with a motor cortex, which may be used for processing instructions. The motor cortex may include one or more central processing unit (CPU) and/or general-purpose computing on graphics processing units (GPGPU). Outputs may be provided from the motor cortex, such as a medulla control stream, one or more illumination outputs (e.g., auto lamp), and/or audio outputs (e.g., speaker). Thus, visual and/or audio outs to be provided by the mobile sensor platform and instructions to the low level controller may be provided from the motor cortex.

The pub/sub router/hub may communicate with various skills environments. Third party developed apps (i.e., non-privileged skills) may run in a sandboxed environment (e.g., skill sandbox) with no external network connectivity or direct sensor access (those are granted only to privileged skills developed by mobile sensing platform administration system or a very well vetted trusted partner). Non-privileged skills may be managed, launched, and deactivated through a skill juggler and recruiter.

Core/privileged skills may be provided via a mobile sensing platform administration system or a trusted partner. Examples of core/privileged skills ma include intention elector, goal elector, and awareness filter that may select relevant sensor information and may remove extraneous information. In some instances, information from the sensor cortex may be provided to the core/privileged skills. This may include raw sensor feed.

When a mobile sensor platform acquires a new skill, that skill can notify the skill recruiter about the channels that it should listen to and the conditions required for the skill to function. The skill juggler may subscribe to the appropriate channels in the pub/sub hub and listens for the conditions required to trigger the skill. When those conditions are met, the skill is launched or activated if it is already running. When the conditions are no longer met, the skill is hibernated (or terminated when there are not enough resources).

Skills may run in a restricted, multi-language run-time. In some embodiments, separate skills can not communicate directly but they can send and receive some data, such as JavaScript Object Notation (JSON) data, by publishing or subscribing to specific channels in the operating system pub/sub hub.

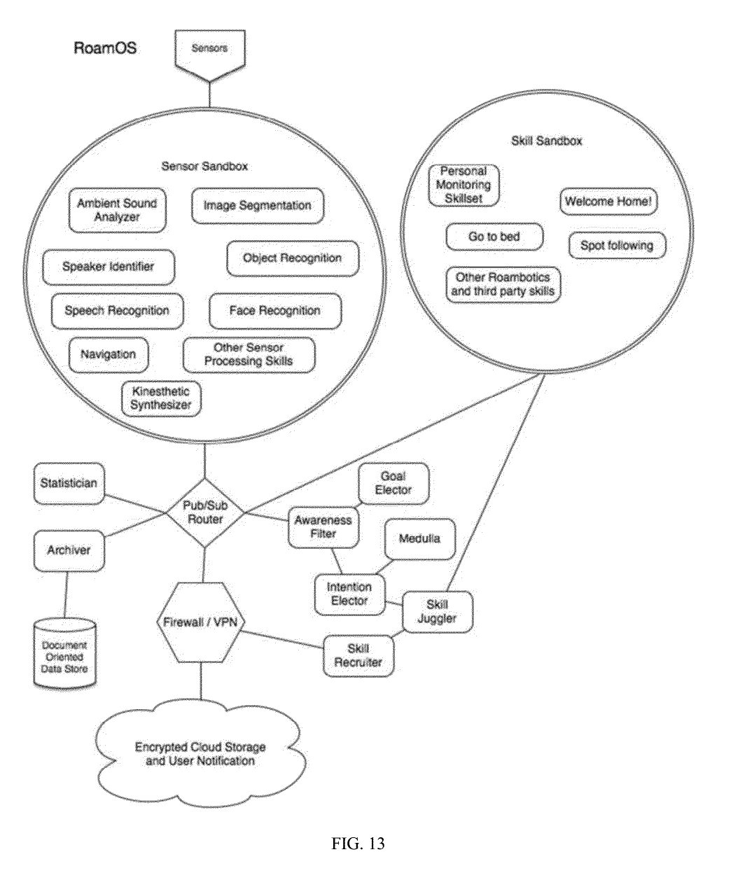

FIG. 13 provides a system for control of an autonomous mobile sensor platform. A pub/sub router may be in communication with various components, such as a statistician, awareness filter, skill recruiter, archiver, and a network. The awareness filter may be in communication with a goal elector and intention elector. The intention elector may communicate with the medulla (low level) controller and skill juggler. The skill recruiter may also communicate with the skill juggler. The archiver may be capable of accessing a document oriented data store. The data store may include one or more databases provided in memory locally or externally relative to the mobile sensor platform. The pub/sub router may be in communication with an encrypted cloud storage and user notification system, optionally through a firewall and/or VPN.

The pub/hub may also be in communication with a sensor sandbox and a skill sandbox. The sensor sandbox may also receive input from one or more sensors of the autonomous mobile sensor platform. Examples of functions provided within the sensor sandbox may include but are not limited to ambient sound analyzer, speaker identifier, speech recognition, navigation, kinesthetic synthesizer, image segmentation, object recognition, face recognition, and/or other sensor processing skills. Examples of skills provided within the skill sandbox may include but are not limited to personal monitoring skillset, go to bed, welcome home, spot following, and other skills which may be core/privileged skills or non-privileged skills.

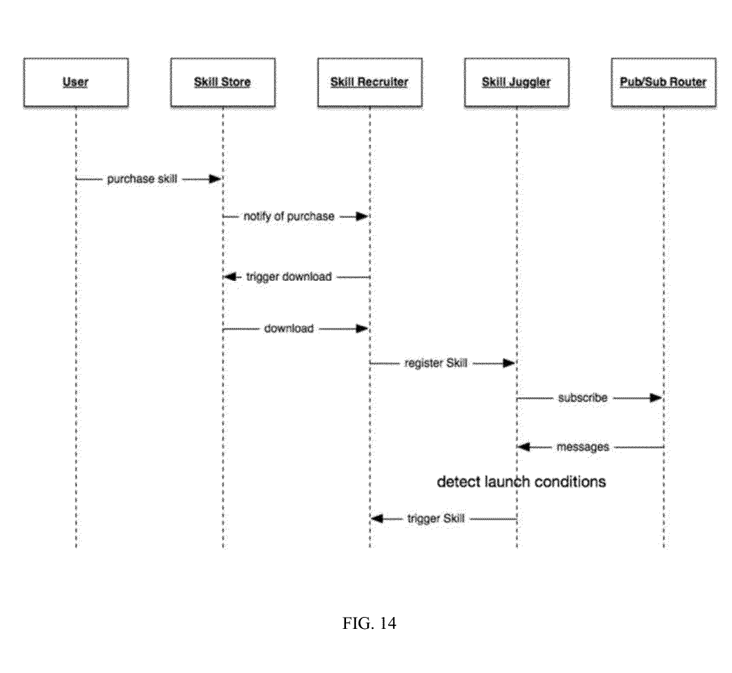

FIG. 14 shows an example of a method for skill acquisition in accordance with an embodiment of the invention. In some embodiments a skill store may be provided. A user may make a purchase of a skill from the skill store. In some instances, the user may pay to purchase a skill, while in other instances, some skills may be accessible for free. In some instances, a skill store may be accessible via a user device, such as a computer or mobile device. The skill store may be owned and/or operated by a mobile sensor platform administration service. The mobile sensor platform administration service may sell and/or provide mobile sensor platforms and/or core/privileged skills. In some instances, the skill store may provide only core/privileged skills. Alternatively, the skill store may also provide non-privileged skills. In some embodiments, a skill store may be provided which may be owned and/or operated by a third party developer.

The skill store may notify a skill recruiter of a purchase. The skill recruiter may be provided locally on the mobile sensor platform or may be communicating with the mobile sensor platform. The skill recruiter may then trigger a download of the purchased skill from the skill store. The download of the purchased skill may occur as a result, to the skill recruiter. In some instances, once the user has made the purchase, such notification and download of the skill may occur immediately after in real-time. In other embodiments, the download may occur at a time where it will not interfere with the functionality of the mobile sensor platform. For example, certain skills may be downloaded while the mobile sensor platform is sleeping or charging.

After the skill has been downloaded, the skill recruiter may contact the skill juggler to register the skill. As previously described, the skill can notify the skill recruiter about the channels that it should listen to and the conditions required for the skill to function. The skill juggler may subscribe to the appropriate channels in the pub/sub router/hub. The pub/sub router/hub may provide messages to the skill juggler. These may include messages indicative of conditions which may be required to trigger the skill. For example, the pub/sub router may receive data from one or more sensors of the mobile sensor platform. When a launch condition is met, the skill is launched or activated if it is already running.

Accordingly, the mobile sensor platform may be capable of evolving and learning new skills. A simple mechanical functionality may be provided. New updates and software may be provided that may permit the mobile sensor platform to function in a desired manner and provide additional complexity in use. A user may be able to personalize functionality and traits that are desired by the user. For example, different users may choose to provide different mobile sensor platforms with different skills to match each of their desired respective uses of the mobile sensor platform. Thus, the addition of new software or skills can change how the physical mobile sensor platform moves about, senses, analyzes, and/or reacts.

### Behavioral User Interface

An autonomous mobile sensor platform does not need to have a display. In some instances, no screen or other visual changeable display is provided. However, it may optionally have a visual display interface. The mobile sensor platform may optionally have a speaker or other audio communication system. Although the mobile sensor platform can produce sound, its primary mode of communicating with users can be its behavior. The behavioral user interface (BUI) includes all aspects of how the mobile sensor platform acts and responds to its environment. This may include movements of the mobile sensor platform, and information conveyed the mobile sensor platform. Further description is provided of a few specific representative examples of the BUI for the mobile sensor platform, but is by no means an exhaustive list.

The BUI can convey information through a very natural feeling and intuitive behavioral patterns, i.e., robot body language. User actions are significant and have easy to understand meanings.

### Functional Design

The autonomous mobile sensor platform design is an integral part of the BUI. Viewing the external design is the first experience users will have with such platforms. They can be clean but inviting and not sterile, overly industrial, or threatening. Size and weight can be selected to convey desired character. Any of the dimensions described elsewhere herein may be provided. The mobile sensor platforms may feel substantial and solid but be easy to carry. To that end, the mobile sensor platforms may include a handle as described. Finally, the mobile sensor platforms can be cool and fun, and further perform useful services.

### Lay to Sleep/Stand to Wake

During use, the autonomous mobile sensor platform may be vertically oriented so that it is balanced on its wheel. This may occur while the autonomous mobile sensor platform is “awake” or capable of moving around or standing at rest. The autonomous mobile sensor may remain substantially vertically oriented while it is sensing the environment around it, whether it is actively moving or not. The autonomous mobile sensor platform may or may not be awake while it is charging.

The mobile sensor platform may be designed to be statically supported lying on its side. In this orientation, the device may go into “sleep” mode. Optionally, during sleep mode, there may be reduced power consumption and disabled motors. While lying on its side, the tire of the mobile sensor wheel may optionally not be contacting the underlying surface.

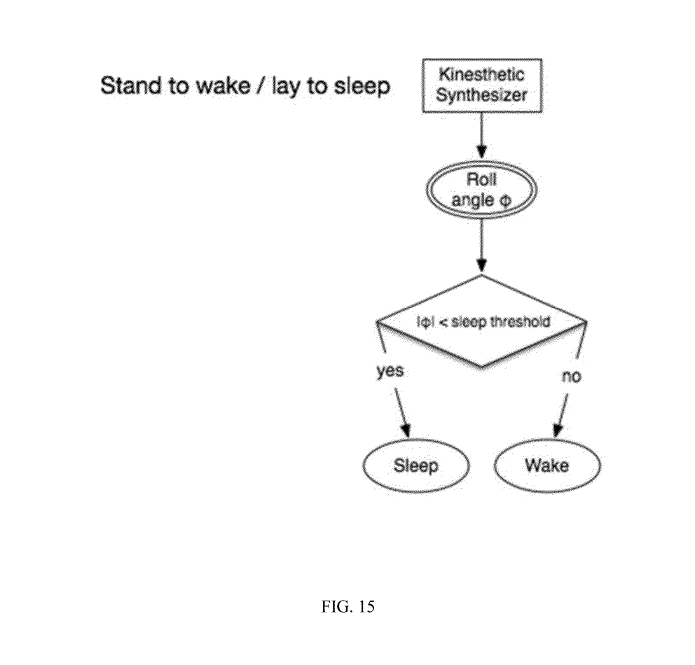

One or more sensors may be provided to detect the orientation of the mobile sensor platform and determine whether it should be awake or asleep. FIG. 15 illustrates an example of using positional information to determine functionality of an autonomous mobile sensor platform. A kinesthetic synthesizer may be provided as part of a mobile sensor platform in accordance with an embodiment of the invention. A roll angle φ of the mobile sensor platform may be detected. If the angle value is less than a predetermined threshold value, the device may be put to sleep. If the angle value is greater than the predetermined threshold value, the device may be awakened. The angle may be measured relative to the surface upon which the device rests, or relative to a plane orthogonal to the direction of gravity.

One or more functionalities may be divided between the awake mode or sleep mode of the platform, or may occur in both modes. In some embodiments, certain updates may occur only while the platform is awake, only while it is asleep, or in both modes regardless of whether it is awake or asleep. In some instances, some sensors may only operate and/or provide data that is analyzed while the platform is awake, while other sensors may also operate and/or provide that is analyzed while the platform is asleep.

In some implementations, the mobile sensor platform can be capable of standing from a laying position in the right set of circumstances under its own power. For example, the platform may be lying on its side while it is asleep. It may sense a condition, such as a loud noise, that may cause it to awake and stand up to investigate.

### Alert Vs Groggy—Battery Status Behavior

Battery charge can be constantly or periodically monitored. When an autonomous mobile sensor platform is fully charged, it may move more quickly and make fewer mistakes. Navigation may be more direct, and it can feel more widely awake. As the power status decreases, the mobile sensor platform performance may gradually slow. The platform may get increasingly “groggy”—i.e., making slight navigation and stabilization errors to give the impression of being tired. This may be useful in alerting users that the mobile sensor platform needs to be charged. The mobile sensor platform may be capable of returning to a charging station of its own volition when it needs to be charged, but the visual effect of grogginess may provide a viewer with a behavioral indicator of the state of charge.

### Curiosity

A mobile sensor platform may have a variety of sensors. Some of the sensors may possibly include ambisonic audio sensors. These sensors can be constantly monitored and processed through ambient sound (and other) analysis. When there is a potentially interesting/significant sound, the mobile sensor platform may navigate to investigate further, possibly triggering behaviors such as sending a notification to the user's mobile device(s).

Sound recognition and analysis software may be provided and/or updated to assist the mobile sensor platform in recognizing which sounds may be potentially interesting or significant. For example, the mobile sensor platform may recognize the sound of breaking glass. Optionally, the mobile sensor platform may recognize the sound of someone yelling for help.

When an interesting sound is detected the mobile sensor platform may approach to investigate further. The mobile sensor platform may capture images, which may aid in further investigation. For example, the mobile sensor platform may capture an image of the proximity of the sound and transmit it to a device of a user. For example, a user who is not at home, may receive on his smartphone, an image of a broken window captured by the mobile sensor platform at home. In another example, the mobile sensor platform may send an alert to a device of the user prior to investigating further. For example, a text message may pop up on a user's phone saying that a suspicious sound was heard. Further details of the sound may also be provided (e.g., a message saying a sound that seems like glass breaking was detected). Optionally, the mobile sensor platform may indicate that the mobile sensor platform will investigate further and provide follow-up information.

### Play

The mobile sensor platforms may include “playful” tendencies. These are behaviors may include simple games like hide-and-seek, tracking and chasing a bright spot (e.g.—laser), detecting that something they have bumped moves or performs in response to their presence. Initially the set of playful behaviors can include a very small set of such behaviors, that may optionally be expanded over time through software updates. In some instances, new skills to be purchased can include new games.

### Presence

In some embodiments, it may be preferable to provide a feeling of a real presence by the mobile sensor platform. This may be provided by the interplay of many behaviors within the mobile sensor platform which may give the user the feeling of a real presence in their home. For example, a user may feel like the home is missing something if the mobile sensor platform is removed (i.e., similar to the feeling if a pet was away at the vet).

### Roaming

A mobile sensor platform may freely traverse an environment in which it is provided. This may include several navigation patterns. In some embodiments, roaming may be a primary mode of operation. The mobile sensor platform may wander with a balance of purpose and randomness. The roaming pattern may require minimal navigation information outside of the immediate environment and gives a way for the mobile sensor platform to sample a large area without feeling creepy or like it is following a specific person. In some instances, roaming may occur in response to a randomized direction selected by the mobile sensor platform. The mobile sensor platform may follow the randomized direction for a predetermined or random length of time before selecting another randomized direction. In some instances, the speed of travel during a roaming mode may be substantially constant or may be varied. During a roaming mode, the mobile sensor platform may locally detect one or more obstructions and either change direction or go around the obstruction.

In other embodiments, the mobile sensor platform may follow one or more pre-set path. For example, the mobile sensor platform may follow a perimeter of a room and circumnavigate obstructions. In other embodiments, the mobile sensor platform may have a pattern of rooms or back and forth routes. In some instances, a user may specify one or more routes. A pre-set route or pattern may be mixed in with roaming. For example, the mobile sensor platform may periodically navigate certain portions of the environment while roaming at other times.

### Walking Style

In some embodiments, each individual mobile sensor platform may have several control parameters that are randomly set on initialization and adjusted over time. These can govern the details of things like recovery time, turning radius, and speed, and consistency of motion. All of these can provide subtle cues to the user to give each mobile sensor platform a distinct feel and style. Because of this and other such BUI features, every mobile sensor platform may feel familiar, but a user's personal mobile sensor platform may feel special and unique.

Many parameters are available for randomized personalization but a few include peak speed and peak acceleration (fast vs slow), default turning radius (sharp or wide), the time constant for recovering when disturbed from standing (quicker or more sluggish), decay rate of control (wobbly vs sharp). In some instances, a user may specify preferences for such movement style by the mobile sensor platform. Alternatively, such parameters may be sent by default and not changeable.

### Wiggling

In some examples, a mobile sensor platform may be able to wiggle side to side (e.g., change tilt angles). The rate of wiggling may be indicative of different states of the mobile sensor platform. For example, a slow lateral wiggle may indicate confusion or a low power state. A more rapid side to side wiggle may indicate excitement.

### Hiding

A mobile sensor platform may be designed to be robust. The mechanical pieces may be simple and less complex to reduce the likelihood of breaking down or creating errors. A housing may be provided that may encase many of the components. However, a mobile sensor platform may still be susceptible to damage inflicted by live beings, such as pets and children. In another example, if an intruder is breaking into the user's home, the intruder may attempt to dismantle the mobile sensor platform. When a potential threat is identified, the mobile sensor platform's response can be to attempt to find a safe hiding spot. In another example, when a potential threat is identified, the mobile sensor platform's response may also include quickly retreating from the threat.

### You're Home!

A mobile sensor platform may be aware when people are home and away, and they can act excited. This may be based on conditions sensed by the mobile sensor platform. For example, if a person returns home and speaks, the mobile sensor platform may recognize the person's voice. The mobile sensor platform may statistically model the level of response and interaction for each person they recognize and develop a level of apparent excitement commensurate with the observed level of response and engagement for each person. For example, when a primary user returns home, the mobile sensor platform may rapidly approach the primary user and move around rapidly. When a guest arrives for the first time, the mobile sensor may approach more cautiously and move around less.

### Laziness

Optionally, the mobile sensor platform can perform the tasks required of them but can also exhibit a certain amount of laziness—an economy of behavior and movement. This can be done to conserve battery power and to give more of a feeling of a real presence in your home that isn't hyperactive and constantly moving. In particular, the mobile sensor platform may have the ability to find a wall or other object and rest by leaning on it. So long as the lean does not exceed a designed angle, the mobile sensor platform is capable of getting back up and moving on its own. The mobile sensor platform may be “awake” while leaning, as opposed to when it falls “asleep” when completely on its side.

The extent of laziness can be a combination of a random parameter set when an individual mobile sensor platform is initialized and learning through statistical inference based on people's degree of interactivity with their mobile sensor platform, ambient light and sound, time of day, and battery status (as well as other factors). In some instances, when not much activity is detected (e.g., no sounds, no one is home), the mobile sensor platform may be more lazy, than when there is more activity (e.g., sounds of people being at home, recent interesting activity).

### Verbal Commands

A mobile sensor platform may have a limited vocabulary. The mobile sensor platform may have one or more audio sensors that may detect sound such as verbal commands from a user. Speech recognition software may be employed to recognize words from verbal commands. This may enable robust, speaker independent speech recognition, and to temper people's expectations (they will understand that the mobile sensor platforms are more like talking to their dog than to a person where recognition and comprehension are not guaranteed and unlikely for all but the simplest requests).

### “Go to Bed”

One particular example is “go to bed” which can send the mobile sensor platform searching for its base station to recharge. In some instances, a user may instruct the mobile sensor platform to go to bed when it notices its behavior is becoming more groggy. This behavior can also be triggered without any user intervention when the battery charge goes below a threshold.

### “Come”

A mobile sensor platform may also knows its name and can respond to the words “come” and “here”, navigating to the person who says one of those and triggering appropriate skills on hearing the command/request and/or on arrival. In some instances, the command, such as “come” may be coupled with a name for the mobile sensor platform that it will recognize so that it does not arrive whenever the word “come” is spoken by a user. For example, if the mobile sensor platform's name is Junior, the mobile sensor platform may approach the user when the user says “come, Junior.”

### “Help!”

A mobile sensor platform may know the word “help” and others with similar meanings in a variety of languages. On hearing these—and particularly when voice stress indicates something important, the mobile sensor platform can notify a third party and trigger other skills. For example, the mobile sensor platform may contact a home security system. In another example, the mobile sensor platform may contact the user, an emergency contact of the user, or emergency services such as law enforcement or medical services.

In some embodiments, the mobile sensor platform may also approach the sound to investigate further. For example, if the mobile sensor platform hears a cry for help, the mobile sensor platform may approach the sound and capture further sounds or images/video from the situation. The visual or audio sensed information may also be transmitted to the appropriate parties, who may determine whether further action is needed.

### Application Programming Interface

Programming robots can be extremely difficult. Mobile sensor platforms can put cameras and other sensitive sensors into people's private spaces.

The mobile sensor platform application programming interface (API) may allow a mobile sensor platform administration system to take care of the major challenges, and to add extensive security while providing high-level abstraction to make programming and distributing skills easily and giving end-users the confidence of knowing that no sensitive sensor data (still or video images; audio recordings) acquired through mobile sensor platform sensors can be used only by them and not viewed by anyone else, including the mobile sensor platform administration team, skill developers, or nefarious third parties.

### Stories

One approach to specifying mobile sensor platform skill applications may include defining “stories” or “mobile sensor platform stories” or “roambot stories.” These can be analogous to the user stories of agile software design, where the mobile sensor platform is the principle actor.

For instance, a story may be formulated as a sentence having the form: <<When [X happens] I do [Y] because [Z]>>, and can include supplemental objective acceptance tests to determine when the story is properly implemented.

Some examples of stories include the following:
When someone picks me up, I stop moving so they don't feel like I'm fighting them.
When someone lays me on my side, I go to sleep so I don't waste power.
When I hear someone cry “help” with elevated voice stress patterns, I go to investigate and notify a contact (e.g., relative, friend) to let them decide how to proceed.
When my battery charge gets low, I slow down and move less precisely to show that I am tired and need to rest.
When my battery charge gets very low, I look around for my docking station and mate with it to recharge.

### Skill Store

The skill store can be a curated garden marketplace where developers can sell vetted skills built using the mobile sensor platform API to end-users. Skills may be analogous to “apps” or applications, and the skill store may be comparable to an “app store” with a similar business model. Skills can include things like image or audio recognizers, new behaviors, navigation patterns, and complex abilities.

Individual skills can expose a push-based API to the pub/sub engine/hub. This API allows skills to interact with one another. Interactions include using data feeds generated by recognizers, triggering behaviors, triggering a navigation pattern, or triggering a user notification.

One key difference between a skill and a conventional app may be in the launcher, or skill recruiter. Once a mobile sensor platform has a skill, it is able to use that skill whenever the right circumstances present themselves. Skills are triggered by a set of circumstances and they can provide new triggers and moderations for those triggers (for example—detecting when someone is busy or watching TV and doesn't want to be disturbed vs when it is a good time to try to engage with them).

Skill launching and control can be observed and fine-tuned in an app, but for the most part, and unlike conventional apps, skills can be triggered and suppressed without any user intervention, and two or more skills can at times interact through a weighted voting process.

### Out of the Box Skill Sets

### Security Monitoring

A mobile sensor platform may be used for security monitoring. For example, a user may use the mobile sensor platform to monitor the user's home. Any other location may be monitored, such as a user's office, workplace, warehouse, shopping center, or other location. Unlike conventional security systems which need to be armed, the mobile sensor platform security monitoring can be passive and automatic. A mobile sensor platform may include several security monitoring skills. The mobile sensor platform may get to know who lives with it and what their normal schedule is. This may occur through a combination of face recognition, speaker identification, and empirical Bayesian statistical analysis. The mobile sensor platform may develop and sense of “normal” conditions that are not cause for alarm. The mobility of the mobile sensor platform may enable it to traverse its environment. In some embodiments, a roaming method of traversal may be used which may make the path of the mobile sensor platform unpredictable, and aid in monitoring security.

Ambient sound analysis can identify potential threats such as arguing, crashes, breaking glass, or forced entry. In some embodiments, certain words may be recognized as being potentially threatening words.

Speaker and face recognition can identify new people who are not a normal part of the household. When someone unknown is detected, the mobile sensor platform notifies its owner and asks them to verify that they belong. If not, the owner is presented with options for notifying local law enforcement or other authorities. The owner may be alerted while the owner is away from home or present at home.

Through a series of such inquiries, the mobile sensor platform may learn what to be concerned about and what is normal to minimize annoying the owner while maximizing the ability to identify security threats.

### Safety Monitoring

In some embodiments, a mobile sensor platform may include smoke and/or temperature detectors. Even without such sensors, a mobile sensor platform can identify patterns that present a safety threat such as visually recognizing flames or smoke. For example, one or more image capture device (e.g., camera) may be used to capture an image around the mobile sensor platform. The image may be analyzed using software to detect whether anything threatening is provided in the image.

When a potential threat is identified a notification can be sent to the owner, and when a critical threat is identified, an alarm is triggered. For example, information may be sent to security companies or emergency response. If a fire is detected, a notification may be sent to send fire fighters. Optionally, an image may be sent to the owner first who may determine whether additional notifications need to be made.

### Personal Monitoring

A mobile sensor platform may be used for personal monitoring. For example, an individual may require additional care or observation. This may occur for health reasons or other reasons. The personal monitoring skill-set makes a mobile sensor platform a careful observer. These skills run in the background and without overtly following whoever is being observed. Instead, the mobile sensor platform may perform its normal behavior. However, when opportunities present themselves, it may notice indicators relating to personal monitoring. These observations may include sleep/wake patterns, when the lights are on or off, when the user is active and when they are sedentary, when they are home and away, and how often they entertain guests. Ambient sound analysis and video recognition of heart rate, respiration, and voice stress level may also be included.

All of these observations feed into the operating system statistician service. The statistician may be instructed to trigger a notification to a healthcare professional or family member when significant changes or downward trends are observed. For example, if an individual become increasingly more sedentary, an alert may be provided to the appropriate contact. In another example, if an individual sleeps or remains in bed for unusual periods of time, appropriate notifications may be made.

In the case of an observed emergency involving someone falling or becoming unconscious, a high priority emergency message is triggered and sent to notify local emergency services.

### Unboxing and Setup

Mobile sensor platforms can be configured through an application, such as an iOS/Android app. In some embodiments, the default is to have them preconfigured when they are shipped. Along with entering payment information, the purchaser may let a mobile sensor platform administration system know their notification preferences including email addresses and other contact information. In this way, a mobile sensor platform can be purchased and setup by someone and shipped to another person who isn't technically savvy. If the end-user does not have WiFi, there is a M2M networking option using a data network, such as Sprint, AT&T, T-mobile, Verizon or any other data network.

A mobile sensor platform may be shipped with a partially charged battery and a “trigger.” In some examples, the mobile sensor platform 1600 may be shipped with a USB key trigger 1640. The mobile sensor platform may have a wheel 1610 around a robot body 1620. The robot body may have a flat top 1625 which may include a port. The USB trigger may be inserted into a port under a handle 1630.

In some embodiments, a mobile sensor platform is provided without a power switch or button. The mobile sensor platform may be activated by removing the USB key which triggers the medulla controller's lay-to-sleep/stand-to-wake mode. Laying the mobile sensor platform on its side puts it to sleep and replacing the key returns the mobile sensor platform to its deactivated mode.

When activated and set on a flat surface, the mobile sensor platform may stand and perform an initial discovery routine which includes a brief introduction, instructions and assistance in setting up the base station and a small “getting to know you” interaction.

Once introductions are complete and the base station is set up, the mobile sensor platform may begin exploring its environment, wandering around and gradually going about its normal routine. It may learn about dimensions of rooms and where obstructions are likely to be provided.

Additional setup, including pairing with user devices, such as smartphone(s) or tablet(s), setting up WiFi and other connections, and adding skills may be done using an application or software. In some instances, set-up may occur via a web page (i.e. status page) accessible via a browser.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A mobile sensor platform comprising:
a wheel that permits the mobile sensor platform to move within an environment including an underlying surface;
a stabilization platform in a body of the mobile sensor platform that is contained within an area circumscribed by the wheel, said stabilization unit causing the wheel to remain balanced upright on the underlying surface without tipping over; and
one or more sensors configured to generate sensing data that aids the mobile sensor platform in moving within the environment.

2. The mobile sensor platform of claim 1 wherein the stabilization platform includes a lateral mass shifting mechanism.

3. The mobile sensor platform of claim 2 wherein the mass shifting mechanism is a linearly displaceable system that restricts movement of a balancing mass in a lateral direction.

4. The mobile sensor platform of claim 3 wherein the linearly displaceable system utilizes a belt and a pulley, or a guide rail or cable.

5. The mobile sensor platform of claim 2 wherein the mass shifting mechanism is a wheel with a mass or a pendulum.

6. The mobile sensor platform of claim 1 wherein the stabilization platform is configured to cause the wheel to remain balanced upright when the mobile sensor platform is in motion and when the mobile sensor platform is stationary.

7. The mobile sensor platform of claim 1 wherein the body of the mobile sensor platform is configured to remain stable and upright while the wheel rotates around the body.

8. The mobile sensor platform of claim 1 wherein the wheel is the only wheel and no other wheels are provided.

9. The mobile sensor platform of claim 1 wherein the one or more sensors are provided in or on the body of the mobile sensor platform.

10. The mobile sensor platform of claim 1 further comprising one or more processors configured to analyze data from the one or more sensors and generate relevant information to be sent to a mobile device of a user of the mobile sensor platform.

11. A mobile sensor platform comprising:
a wheel that permits the mobile sensor platform to move within an environment including an underlying surface;
a body of the mobile sensor platform that is contained within an area circumscribed by the wheel; and
a plurality of sensors of multiple types in or on the body and configured to generate sensing data that aids the mobile sensor platform in moving autonomously within the environment without requiring human intervention.

12. The mobile sensor platform of claim 11 wherein the sensing data from the one or more sensors permit the mobile sensor to avoid obstacles in the environment.

13. The mobile sensor platform of claim 11 further comprising one or more processors configured to analyze data from the one or more sensors and generate relevant information to be sent to a mobile device of a user of the mobile sensor platform.

14. The mobile sensor platform of claim 14 wherein the relevant information sent to the mobile device permits the user to view one or more images captured by the mobile sensor platform.

15. The mobile sensor platform of claim 11 further comprising an on-board energy storage unit within or on the body, wherein the mobile sensor platform is capable of communicating with a charging station configured to charge the energy storage unit.

16. The mobile sensor platform of claim 11 wherein the mobile sensor platform is configured such that (1) the wheel remains balanced upright on the underlying surface without tipping over when the mobile sensor platform is in an awake mode, and (2) the mobile sensor platform lies supported on its side during a sleep mode, wherein the sleep mode has reduced power consumption relative to the awake mode.

17. The mobile sensor platform of claim 15 wherein a power level of the on-board energy storage unit is monitored, and wherein the mobile sensor platform is configured to make slight navigation and stabilization errors when the power level is lower relative to when the power level is higher.

18. The mobile sensor platform of claim 11 further comprising one or more audio sensors, wherein the mobile sensor platform is configured to respond to verbal commands detected by the one or more audio sensors.

19. A system for controlling a mobile sensor platform comprising:
a low level control system for the mobile sensor platform, wherein the mobile sensor platform comprises (a) a wheel that permits the mobile sensor platform to move within an environment, (b) a body of the mobile sensor platform that is contained within an area circumscribed by the wheel, and (c) one or more sensors configured to generate sensing data that aids the mobile sensor platform in moving within the environment, and wherein the low level control system controls basic stabilization, inertial navigation and collision avoidance of the mobile sensor platform; and
a high level control system for the mobile sensor platform, wherein the high level control system runs an operating system for the mobile sensor platform.

20. The system of claim 19 wherein the high level control system is configured to run third party applications in a sandboxed environment.
